(19) United States
(12) Patent Application Publication
(10) Pub. No.: US 2016/0304725 A1
(43) Pub. Date: Oct. 20, 2016

(54) Liquid Drywall Composition and Methods of Use

(71) Applicant: American Building Restoration Products Inc., Franklin, WI (US)

(72) Inventor: Jack E. Tadych, Franklin, WI (US)

(21) Appl. No.: 15/097,432

(22) Filed: Apr. 13, 2016

Related U.S. Application Data
(60) Provisional application No. 62/147,766, filed on Apr. 15, 2015.
(60) Provisional application No. 62/262,488, filed on Dec. 3, 2015.

(51) Int. Cl. C09D 5/18; E04C 2/284; C09D 133/00

(52) U.S. Cl. CPC C09D 5/18; C09D 133/00; E04C 2/284

(57) ABSTRACT

The present disclosure is directed to a coating composition, and specifically a sandable coating composition, as well as methods of using the coating composition, methods of finishing surfaces using the coating composition and surfaces comprising a coating. The sandable coating composition includes a base resin, a flame retardant and, optionally, a pigment. In one embodiment, the flame retardant is boric acid and the pigment when present is a dry, white pigment, such as titanium dioxide. The coating is comparable to drywall and may in some instances be used as a replacement to traditional drywall, resulting in cost savings (less labor and materials) and time savings.

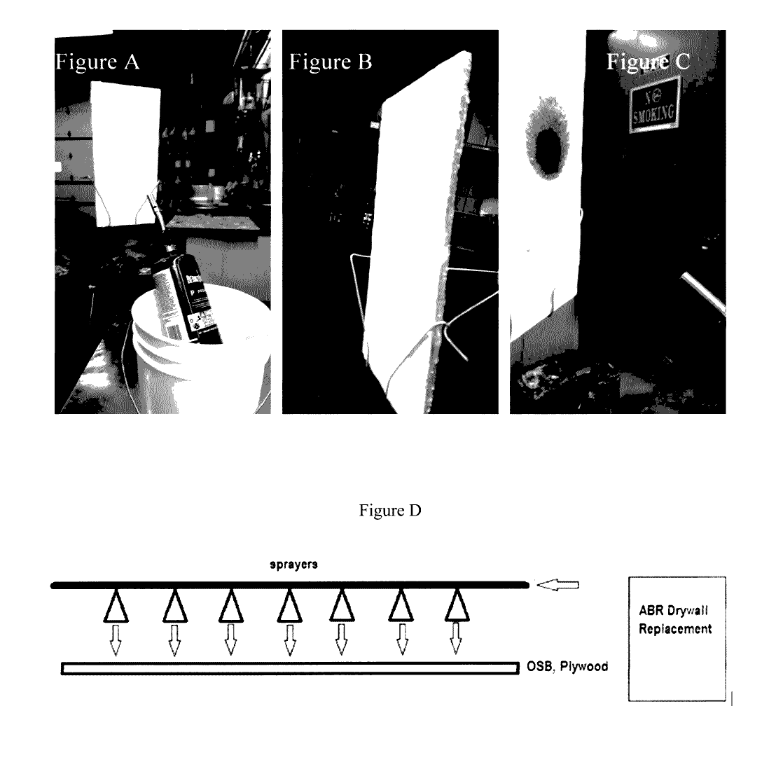

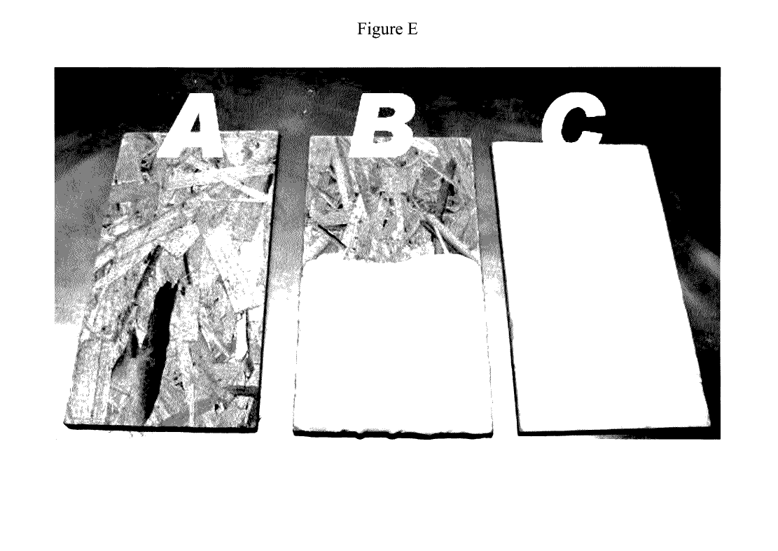

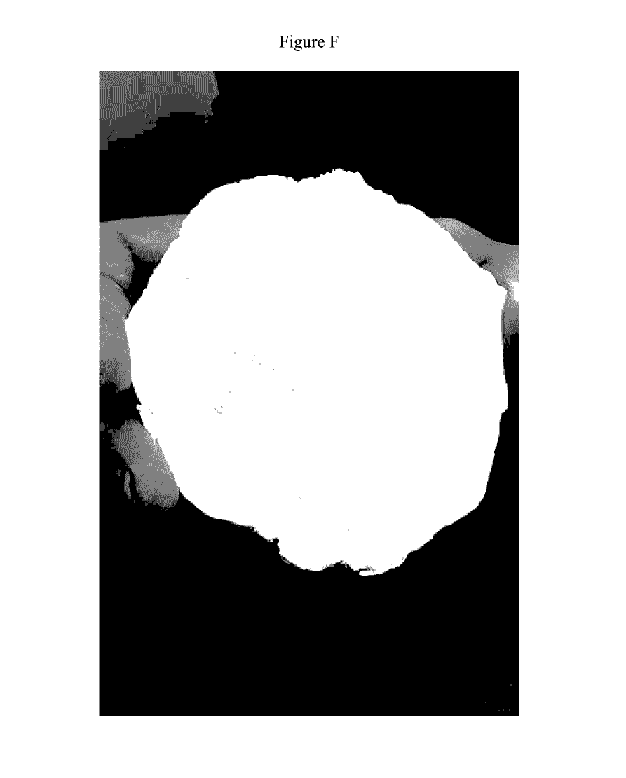

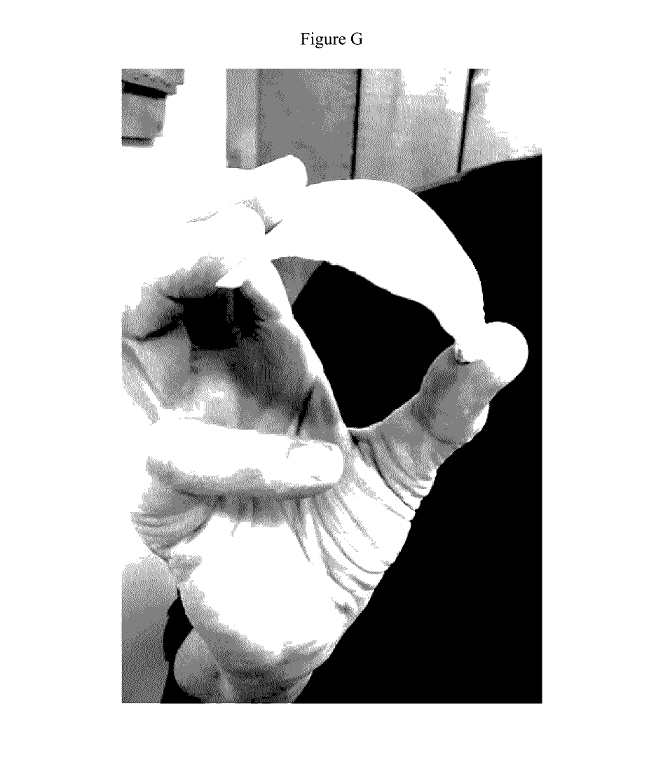

### FIELD OF THE DISCLOSURE

The present disclosure relates to coatings for finishing walls and methods for finishing walls by applying a coating. Specifically, the present disclosure relates to coatings for finishing walls which replace traditional drywall and methods for finishing walls using the same.

### BACKGROUND

Traditional drywall (also known as plasterboard, wallboard, and gypsum board) is a panel made of gypsum plaster pressed between two thick sheets of paper. The raw gypsum, CaSO₄.2 H₂O, is heated to drive off the water then slightly re-hydrated to produce the hemihydrate of calcium sulfate (CaSO₄.1/2 H₂O). The plaster is mixed with fiber (typically paper and/or fiberglass), plasticizer, foaming agent, finely ground gypsum crystal as an accelerator, EDTA, starch or other chelate as a retarder, various additives that may decrease mildew and increase fire resistance (fiberglass or vermiculite), and wax emulsion or silanes for lower water absorption. The board is then formed by sandwiching a core of the wet mixture between two sheets of heavy paper or fiberglass mats. When the core sets it is then dried in a large drying chamber, and the sandwich becomes rigid and strong enough for use as a building material.

Drying chambers typically use natural gas today. To dry 1 MSF (1,000 square feet (93 m²)) of wallboard, between 1,750,000 and 2,490,000 BTU (1,850,000 and 2,630,000 kJ) is required. Organic dispersants/plasticizers are used so the slurry will flow during manufacture, and to reduce the water and hence the drying time

To install drywall, the panels are hung on studs or other framing components to create interior walls and/or ceilings. In other uses, drywall may be hung directly on a solid surface, such as over oriented strand board (OSB) or plywood. For example, many buildings, including, for example, houses and other structures, are made using Structural Insulated Panels (SIPs). SIPs contain a foam insulating panel between two outer panels, typically made of OSB. When used for building structures, the drywall panels are hung directly on the SIPs, specifically on an outer OSB panel of a SIP. After drywall panels are hung, the seams need to be mudded and the corners need to be covered with paper tape and/or beaded. The mudding, taping and/or beading needs to be repeated at least twice, with the mudding compound carefully feathered away from the seams/corners so that they blend in with the drywall panels. After mudding, taping and beading, the panels still need to be sanded and finished.

In addition to being time-consuming, as described above, traditional drywall adds weight and cost (both labor and material) to many projects. It is desirable to use the largest drywall panels possible for a job to reduce the number of seams. For example, a single 4 feet by 12 feet sheet of ⅝ inch think drywall can weigh about 105 pounds.

A need therefore exists for a coating which among other things can be applied on a surface, such as a wall, which eliminates or reduces the need for drywall and/or reduces the costs associated with traditional drywall installation.

### SUMMARY

The present disclosure is directed to a coating composition, and specifically a sandable coating composition, as well as methods of using the coating composition, methods of finishing surfaces using the coating composition and surfaces comprising a coating.

The coating is comparable to drywall when applied to a surface or substrate and may in some instances be used as a replacement to traditional drywall when applied to a surface, resulting in cost savings (less labor and materials) and time savings. In embodiments in which the coating includes a pigment, the coating may act as a final coat on the surface or substrate. In embodiments in which the coating does not include a pigment, the coating may function as a clear primer to be painted over.

In one embodiment, the present disclosure provides a sandable coating composition includes a base resin and a flame retardant. In a further embodiment, the sandable coating composition may further include a pigment.

In one embodiment, the coating composition comprises 70-25 wt % of a base resin, based on the total weight of the composition, and 70-10 wt % of a flame retardant comprising boric acid, based on the total weight of the composition, wherein the base resin comprises an aqueous acrylic polymer emulsion.

In one embodiment, the disclosure provides a structural insulated panel comprising a middle foam panel sandwiched between two oriented strand boards, wherein at least one of the oriented strand boards is coated with a composition comprising 70-25 wt % of a base resin, based on the total weight of the composition, and 70-10 wt % of a flame retardant comprising boric acid, based on the total weight of the composition.

In one embodiment, the disclosure provides a method of finishing a surface comprising applying a sandable coating composition to the surface, the sandable coating composition comprising 70-25 wt % of a base resin, based on the total weight of the composition, and 70-10 wt % of a flame retardant comprising boric acid, based on the total weight of the composition; allowing the sandable coating formulation to dry on the surface; and, optionally, sanding the dried coating.

In one embodiment, the disclosure provides a substrate coated with a composition comprising 70-25 wt % of a base resin, based on the total weight of the composition, and 70-10 wt % of a flame retardant comprising boric acid, based on the total weight of the composition.

In one embodiment, the disclosure provides a structure in combination with a sandable formulation, the combination comprising a structure having a surface and a sandable coating composition comprising 70-25 wt %, based on the total weight of the composition, of a base resin, 70-10 wt %, based on the total weight of the composition, of a flame retardant comprising boric acid, and, optionally, a pigment, the sandable coating composition applied to the surface to provide a finished or finishable surface.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features of the present disclosure which are believed to be novel are set forth with particularity in the appended claims. Embodiments of the disclosure are disclosed with reference to the accompanying drawings and are for illustrative purposes only. The disclosure is not limited in its application to the details of construction or the arrangement of the components illustrated in the drawings. The disclosure encompasses other embodiments and is capable of being practiced or carried out in other various ways. The drawings illustrate a best mode presently contemplated for carrying out the invention. Like reference numerals are used to indicate like components. In the drawings:

FIGURE A is a photograph showing the set-up for a burn test of an OSB panel coated with an exemplary coating in accordance with embodiments of the present disclosure;

FIGURE B is a coated OSB panel in accordance with embodiments of the present disclosure after exposure to a propane flame at 8 inches for 10 minutes;

FIGURE C is a coated OSB panel in accordance with embodiments of the present disclosure after exposure to a propane flame at 6 inches for 10 minutes;

FIGURE D illustrates an exemplary method of applying a coating in accordance with embodiments of the present disclosure;

FIGURE E illustrates an alternative exemplary method of applying a coating in accordance with embodiments of the present disclosure;

FIGURE F is a flexible sheet of coating which has been dried on a flat surface and is ready to be applied to a surface using, for example, an adhesive, in accordance with embodiments of the present disclosure; and

FIGURE G is a flexible sheet of coating which has been dried on a flat surface and which is bent to show a degree of flexibility in accordance with embodiments of the present disclosure.

### DETAILED DESCRIPTION

### Coating Composition

In an embodiment, the present disclosure is directed to a composition for a coating, and preferably a composition for a sandable coating.

In an embodiment, the present disclosure is directed to a coating, and preferably a sandable coating.

In embodiment, the coating has properties and/or performance attributes (e.g., flame retardance, finish, texture, etc.) comparable and/or similar to that of traditional drywall panels when applied to a surface. The composition may therefore be referred to as liquid drywall or a liquid drywall composition.

In one embodiment, the composition comprises a base resin, a flame retardant and a pigment. In one embodiment, the flame retardant contributes to the sandable property of the composition. In further embodiments, the composition may contain a further, separate sandable mixture in addition to the flame retardant. In still further embodiments, a flame retardant may be provided as a component of sandable mixture.

In one embodiment, the base resin comprises an acrylic emulsion, such as, for example, an aqueous acrylic polymer emulsion. Aqueous acrylic polymer emulsions useful in the present composition are typically alkaline with a solids content of approximately 40-55%, preferably 45-50%, and a specific gravity of 0.8-1.25, preferably 0.9-1.1. One exemplary aqueous acrylic polymer emulsion is commercially available as Rhoplex™ MC-1834, available from Rohm ad Haas. Other suitable aqueous polymer emulsions include Flex Bond 132™ Emulsion (available from Ashland Chemical) and Vinyblan 271™ Emulsion (available from Nissin Chemical).

In one embodiment, the acrylic emulsion is present in an amount of from 90 weight percent (wt %), or from 85 wt % to 75 wt %, or to 80 wt % based on the total weight of the base resin. In an embodiment, the acrylic emulsion is present in an amount of 92.4 wt % based on the total weight of the base resin.

In one embodiment, the base resin comprises a defoamer. Suitable defoamers are those known and used in the art to control foam and reduce microfoam. Preferably, the defoamer used in the present composition is a nonionic defoamer, and more preferably a nonionic, organic defoaming/de-aerating wetting agent. In one embodiment, the defoamer is void of silicone. In one embodiment, the defoamer is void of mineral oil. One exemplary defoamer is commercially available as Surfynol MD20, available from Air Products.

In an embodiment, the defoamer is present in an amount of from 3 wt %, or from 2 wt %, or from 1.25 wt % to 0.85 wt %, or to 0.75, or to 1 wt % based on the total weight of the base resin. In an embodiment, the defoamer is present in an amount of 1.053 wt % based on the total weight of the base resin.

In one embodiment, the base resin comprises one or more rheology modifiers (thickener and/or suspending agent).

In an embodiment, the rheology modifier is made from processed attapulgite, a hydrated magnesium aluminosilicate having an ideal formula of 3MgO-1.5Al₂O₃-8SiO₂-9H₂O. In an embodiment, the attapulgite rheology modifier is a micronized powder having an average particle size of 0.05-0.2 um, or preferably 0.1 um. Preferably, the attapulgite rheology modifier has a Hegman fineness of grind (in dioctyl phthalate) of greater than 5. Exemplary rheology modifiers are commercially available as Attagel® attapulgite rheology modifiers available from BASF, such as, for example, Attagel® 40 or Attagel® 50.

In one embodiment, when the rheology modifier is an attapulgite-based rheology modifier, the attapulgite rheology modifier is present in an amount of from 5 wt %, or from 4 wt %, or from 3 wt % to 0.5 wt %, or to 0.75 wt %, or to 1 wt % based on the total weight of the base resin. In an embodiment, the rheology modifier is present in an amount of 1.178 wt % based on the total weight of the base resin.

In one embodiment, the rheology modifier is a nonionic, non-pH dependent thickener imparting a nearly Newtonian rheology. In an embodiment, such a thickening agent has a Brookfield viscosity of 8,000-30,000 and a specific gravity of from 0.75, or from 0.85, or from 0.95 to 1.25, or to 1.15, or to 1.10. In an embodiment, the thickening agent has a specific gravity of 1.08. Exemplary thickening agents are commercially available as Acrysol™ nonionic, non-pH dependent rheology modifiers (e.g., Acrysol™ RM-8) available from The Dow Chemical Company.

In one embodiment, when the rheology modifier is a nonionic, non-pH dependent thickener, the rheology modifier is present in an amount of from 5 wt %, or from 4 wt %, or from 3 wt % to 0.5 wt %, or to 0.75 wt %, or to 1 wt % based on the total weight of the base resin. In an embodiment, the rheology modifier is present in an amount of 1.508 wt %.

In one embodiment, the base resin comprises both an attapulgite-based rheology modifier and a nonionic, non-pH dependent thickener in the amounts as specified above.

In one embodiment, the base resin comprises a solvent, preferably an organic solvent, such as, for example, n-methyl-2-pyrrolidine (NMP), an organosulfur solvent, such as, for example, dimethyl sulfoxide (DMSO), or a dimethyl ester.

In an embodiment, the solvent is NMP, DMSO or a dimethyl ester. In an embodiment, the solvent is NMP. In an embodiment, the solvent is DMSO.

In an embodiment, the solvent is present in an amount of from 5 wt %, or from 4 wt %, or from 3 wt % or from 2 wt % to 0.5 wt %, or to 0.75 wt %, or to 0.9 wt %, or to 1 wt % based on the total weight of the base resin. In an embodiment, the solvent is present in an amount of 1.107 wt % based on the total weight of the base resin.

In an embodiment the base resin comprises a surfactant. Surfactants suitable for use in the base resin include those typically known and used in the art. An exemplary surfactant is commercially available as Aerosol® TR-70, available from Cytec.

In an embodiment, the surfactant is present in an amount of from 8 wt %, or from 6.5 wt %, or from 5 wt % to 1 wt %, or to 1.5 wt %, or to 2 wt % based on the total weight of the base resin. In an embodiment, the surfactant is present in an amount of 3.267 wt % based on the total weight of the base resin.

In an embodiment, the base resin comprises an ether-functionalized solvent such as, for example, diethylene glycol monohexyl ether commercially available as Hexyl CARBITOL Solvent, available from The Dow Chemical Company.

In an embodiment, the ether-functionalized solvent is present in an amount of from 3 wt %, or from 2 wt %, or from 1 wt % to 0.25 wt %, or to 0.3 wt %, or to 0.5 wt % based on the total weight of the base resin. In an embodiment, the ether-functionalized solvent is present in an amount of 0.503 wt % based on the total amount of the base resin.

In one embodiment, the base resin comprises water as an additional component over and above any water which may inherently be present in any of the earlier listed components of the base resin. In an embodiment, the water may be purified and/or deionized.

In further embodiments, however, it is contemplated that a version of an aqueous acrylic polymer emulsion useful in the base resin may have an amount of water sufficient such that additional water, above and beyond what is contained in the aqueous emulsion, is not necessary. In such embodiments, however, the relative amounts of the other components of the base resin may need to be adjusted to account for the amount of water and/or amount of aqueous acrylic polymer used to achieve the desired water content.

In one embodiment, the water is present in an amount of from 12 wt %, or from 11 wt %, or from 10 wt % to 0 wt %, or to 5 wt %, or to 6 wt %, or to 7 wt % based on the total weight of the base resin. In an embodiment, the water is present in an amount of 8.29 wt % based on the total weight of the base resin.

In one embodiment, the base resin comprises the following composition:

TABLE 1

| | | | | Exemplary |
|---|---|---|---|---|
| | | Range | Preferred Range | Composition |
| Component | Example | (% by weight) | (% by weight) | (% by weight) |
| Aqueous Acrylic | Rhoplex MC-1834 | 90-75 | 85-80 | 82.4 |
| Polymer | | | | |
| Emulsion | | | | |
| Defoamer | Surfynol MD20 | 3-0.85 | 1.25-.75 | 1.053 |
| | Oxirane, [[(2- | | | |
| | ethyhexyl)oxy]methyl]-, | | | |
| | reaction product: with | | | |
| | polyethylene glycol ether | | | |
| | with 2,4,7,9-tetramethyl-5- | | | |
| | decyne-4-,7-diol(2:l) | | | |
| Water | | 12-0 | 10-5 | 8.29 |
| Rheology | Attagel 50 | 5-.5 | 3-1 | 1.178 |
| modifier | attapulgite clay | | | |
| Thickening | Acrylsol RM-8 | 5-.5 | 3-1 | 1.508 |
| Agent | Polyurethane resin/ | | | |
| | propylene glycol/water | | | |
| | at about 35:39:26 ratio | | | |
| Solvent | n-methyl-2-pyrrolidine, | 5-.5 | 3-1 | 1.107 |
| | dimethyl sulfoxide, or | | | |
| | other dimethyl esters | | | |
| Surfactant | Aerosol TR-70% | 8-1 | 5-2 | 3.267 |
| | sodium bistridecyl | | | |
| | sulfosuccinate in mixture | | | |
| | of ethanol and water | | | |
| Solvent | Hexyl carbitol ®; solvent; | 5-.5 | 3-1 | 1.178 |
| | diethylene glycol | | | |
| | monohexyl ether | | | |

In the embodiments described above, the amount of the components in the base resin is determined at the time the components of the base resin are mixed together. In other words, the weight percent is the weight percent as calculated at the time the base resin is made. It will be appreciated by one skilled in the art that the relative amounts of the components may vary slightly if the base resin is allowed to stand or otherwise be exposed to air. Such variation may be attributable, in some embodiments, to evaporation, curing, and/or absorption of water by components of the base resin.

In one embodiment, the base resin is commercially available as Liquid Shield from ABRP.

In one embodiment, the base resin is present in the coating composition in an amount of from 70 wt %, or from 65 wt %, or from 60 wt %, or from 55 wt %, or from 50 wt %, or from 45 wt %, or from 40 wt %, or from 38 wt % to 25 wt %, or to 30 wt %, or to 35 wt %, or to 40 wt %, or to 45 wt %, or to 50 wt % based on the total weight of the coating composition. In an embodiment, the base resin is present in an amount of 37.5 wt % based on the total weight of the coating composition. In an embodiment, the base resin is present in an amount of 38.7 wt % based on the total weight of the coating composition. In an embodiment, the base resin is present in an amount of 55 wt % based on the total weight of the composition.

In an embodiment, the composition includes a pigment and does not include a sandable mixture, and the base resin is present in an amount of from 50 wt %, or from 45 wt %, or from 40 wt % or from 38 wt % to 25 wt %, or to 30 wt %, or to 35 wt %, based on the total weight of the coating composition. In an embodiment, the composition includes a pigment and does not include a sandable mixture, and the base resin is present in an amount of 37.5 wt % based on the total weight of the coating composition.

In an embodiment, the composition does not include a pigment or a sandable mixture and that base resin is present in an amount of from 50 wt %, or from 45 wt %, or from 40 wt % or from 38 wt % to 25 wt %, or to 30 wt %, or to 35 wt %, based on the total weight of the coating composition. In an embodiment, the composition does not include a pigment or a sandable mixture, and the base resin is present in an amount of 38.7 wt % based on the total weight of the coating composition.

In an embodiment, the composition includes a sandable mixture and the base resin is present in an amount of from 65 wt %, or from 60 wt % to 30 wt %, or to 40 wt %, or to 45 wt %, or to 50 wt % based on the total weight of the coating composition. In an embodiment, the composition includes a sandable mixture the base resin is present in an amount of 54 wt % to 58 wt % based on the total weight of the coating composition.

In an embodiment in which the coating composition includes a sandable mixture and a pigment, the base resin is present in an amount of from 54 wt % to 56 wt % based on the total weight of the coating composition. In such an embodiment, the base resin may be present in an amount of 55 wt % based on the total weight of the composition.

In an embodiment in which the coating composition includes a sandable mixture but does not include a pigment, the base resin is present in an amount of from 56 wt % to 58 wt %, based on the total weight of the coating composition. In such an embodiment, the base resin may be present in an amount of 57 wt % based on the total weight of the coating composition.

In one embodiment, the flame retardant is an intumescent flame retardant.

In on embodiment, the flame retardant is selected from the group consisting of inorganic flame retardants (including, for example, aluminum trihydroxide (ATH), magnesium hydroxide (MIDH), antimony, boron, zinc, etc.), halogenated organic flame retardants (including, for example, those comprising decabromodiphenyl ether (decaBDE), brominated carbonate oligomers (BCOs), bromiated epoxy oligomers (BEOs), tetrabromobisphenol A (TBBPA), hexabromocyclododecane (HBCD), chlorinated paraffins, etc.), and organophosphorus compounds (including, for example, organophosphates, tris(1,3-dichloro-2-prpoyl)phosphate (TDCP), tris(2-chloroethyl)phosphate (TCEP), “Tris” (TDCP and TCEP), triphenyl phosphate (TPP), resorcinol diphenyl phosphate (RDP), bisphenol A bis-(diphenyl phosphate) (BPADP), tri-o-cresyl phosphate, dimethyl methylphosphonate (DMMP), etc.).

In one embodiment, the flame retardant has a regular particle size of from 1 mil, or from 2 mils, or from 3 mils, or from 4 mils, or from 5 mils to 12 mils, or to 11 mils, or to 10 mils, or to 9 mils, or to 8 mils. In one embodiment, the flame retardant has a regular particle size of 5 to 8 mils. In one embodiment, the flame retardant has a regular particle size of 2 to 3 mils.

In one embodiment, the flame retardant is boric acid. Preferably, the flame retardant is boric acid having a regular particle size of from 1 mil, or from 2 mils, or from 3 mils, or from 4 mils, or from 5 mils to 12 mils, or to 11 mils, or to 10 mils, or to 9 mils, or to 8 mils. In one embodiment, the flame retardant has a regular particle size of 5 to 8 mils. Applicant discovered that using boric acid powder (e.g., boric acid with a regular particle size of 2-3 mils) resulted in a decrease in flexibility of the coating.

Not to be bound by any particular theory, it is thought the particle size of the flame retardant (e.g., boric acid) used contributes to the sandable nature of the coating. If the particle size is too great, the coating may crumble instead of sand. If the particle size is too small, the coating may not sand properly.

Boric acid not only helps create a sandable coating and provides fire retardance, but also provides an insecticide property to the coating.

In an embodiment, boric acid is commercially available as Optibor® Boric Acids from US Borax, Inc. In an embodiment, the boric acid is a powdered boric acid commercially available as Optibor® Boric Acids from US Borax, Inc. (e.g., Technical Grade Powder Optibor®, National Formulary Powder Optibor®)

In an embodiment, the flame retardant is present in an amount of from 70 wt, or from 65 wt %, or from 62 wt %, or from 40 wt %, or from 35 wt %, or from 30 wt % or from 25 wt % to 10 wt %, or to 15 wt %, or to 18 wt %, or to 20 wt %, or to 30 wt %, or to 40 wt %, or to 50 wt %, or to 55 wt % based on the total weight of the coating composition.

In an embodiment in which the coating composition does not include a sandable mixture, the flame retardant is present in an amount of from 70 wt %, or from 65 wt %, or from 62 wt % to 30 wt %, or to 40 wt %, or to 50 wt %, or to 55 wt %. In a further embodiment in which the coating composition does not include a sandable mixture, the flame retardant is present in an amount of 59 wt % to 62 wt % based on the total weight of the coating composition. In a further embodiment in which the coating composition does not include a sandable mixture, the flame retardant is present in an amount of 59 wt % to 60 wt % based on the total weight of the coating composition. In a further embodiment in which the coating composition does not include a sandable mixture, the flame retardant is present in an amount of 59 wt %, or 59.375 wt % based on the total weight of the coating composition. In an embodiment in which the coating composition does not include a sandable mixture, the flame retardant is present in an amount of 61 wt % to 62 wt % based on the total weight of the coating composition. In an embodiment in which the composition does not include a sandable mixture, the flame retardant is present in an amount of 61 wt %, or 61.29 wt %.

In an embodiment, the composition includes a pigment and does not include a sandable mixture, and the flame retardant is present in an amount of 59 wt % to 60 wt % based on the total weight of the coating composition. In an embodiment, the composition includes a pigment and does not include a sandable mixture, and the flame retardant is present in an amount of 59 wt %, or 59.375 wt % based on the total weight of the coating composition.

In an embodiment, the composition does not include a pigment or a sandable mixture, and the flame retardant is present in an amount of 61 wt % to 62 wt % based on the total weight of the coating composition. In an embodiment, the composition does not include a pigment or sandable mixture and the flame retardant is present in an amount of 61 wt %, or 61.29 wt %.

In an embodiment, the composition includes a sandable mixture and the flame retardant is present in an amount of from 40 wt %, or from 35 wt %, or from 30 wt %, or from 25 wt % to 10 wt %, or to 15 wt %, or to 18 wt %, or to 20 wt %, based on the total weight of the coating composition. In such a further embodiment, the flame retardant is present in an amount of from 20 wt % to 22 wt % based on the total weight of the coating composition.

In one embodiment, the composition includes both a sandable mixture and a pigment, and the flame retardant is present in an amount of from 20 wt % to 21 wt %, based on the total weight of the coating composition. In such a further embodiment, the flame retardant is present in an amount of 20.7 wt % based on the total weight of the coating composition.

In an embodiment, the coating composition includes a sandable mixture and no pigment, and the flame retardant is present in an amount of from 21 wt % to 22 wt %, based on the total weight of the composition. In such a further embodiment, the flame retardant is present in an amount of 21.47 wt %, based on the total weight of the coating composition.

In an embodiment, the flame retardant is boric acid and is present in an amount of from 70 wt %, or from 65 wt %, or from 62 wt %, or from 40 wt %, or from 35 wt %, or from 30 wt %, or from 25 wt % to 10 wt %, or to 15 wt %, or to 18 wt %, or to 20 wt %, or to 30 wt %, or to 40 wt %, or to 50 wt %, or to 55 wt % based on the total weight of the coating composition.

In an embodiment in which the coating composition does not includes a sandable mixture, the flame retardant is boric acid and is present in an amount of from 70 wt %, or from 65 wt %, or from 62 wt % to 30 wt %, or to 40 wt %, or to 50 wt %, or to 55 wt %. In a further embodiment in which the composition does not include a sandable mixture, the flame retardant is boric acid and is present in an amount of 59 wt % to 62 wt % based on the total weight of the coating composition. In a further embodiment in which the coating composition does not include a sandable mixture, the flame retardant is boric acid and is present in an amount of 59 wt % to 60 wt % based on the total weight of the coating composition. In a further embodiment in which the coating composition does not include a sandable mixture, the flame retardant is boric acid and is present in an amount of 59 wt %, or 59.375 wt % based on the total weight of the coating composition. In an embodiment in which the coating composition does not include a sandable mixture, the flame retardant is boric acid and is present in an amount of 61 wt % to 62 wt % based on the total weight of the coating composition. In an embodiment in which the coating composition does not include a sandable mixture, the flame retardant is boric acid and is present in an amount of 61 wt %, or 61.29 wt %.

In an embodiment, the composition includes a pigment and does not include a sandable mixture, and the flame retardant is boric acid and is present in an amount of 59 wt % to 60 wt % based on the total weight of the coating composition. In an embodiment, the composition includes a pigment and does not include a sandable mixture, and the flame retardant is boric acid and is present in an amount of 59 wt %, or 59.375 wt % based on the total weight of the coating composition.

In an embodiment, the composition does not include a pigment or a sandable mixture, and the flame retardant is boric acid and is present in an amount of 61 wt % to 62 wt % based on the total weight of the coating composition. In an embodiment, the composition does not include a pigment or a sandable mixture, and the flame retardant is boric acid and is present in an amount of 61 wt %, or 61.29 wt %.

In an embodiment, the coating composition includes a sandable mixture and the flame retardant is boric acid and is present in an amount of from 40 wt %, or from 35 wt %, or from 30 wt %, or from 25 wt % to 10 wt %, or to 15 wt %, or to 18 wt %, or to 20 wt %, based on the total weight of the coating composition. In such a further embodiment, the flame retardant is present in an amount of from 20 wt % to 22 wt % based on the total weight of the coating composition.

In one embodiment, the composition includes both a pigment and a sandable mixture, and the flame retardant is boric acid and is present in an amount of from 20 wt % to 21 wt % based on the total weight of the coating composition. In such a further embodiment, the flame retardant is boric acid and is present in an amount of 20.7 wt % based on the total weight of the coating composition.

In one embodiment, the coating composition includes a sandable mixture and no pigment, and the flame retardant is boric acid and is present in an amount of from 21 wt % to 22 wt %, based on the total weight of the composition. In such a further embodiment, the flame retardant is boric acid and is present in an amount of 21.47 wt % based on the total weight of the coating composition.

Boric acid is not found in traditional drywall formulations. Applicant surprisingly discovered that the inclusion of boric acid, or other flame retardant having similar physical and/or chemical properties, including, for example, particle size, provided not only flame retardancy to its composition, but also resulted in a sandable composition without detracting from the composition's flexibility. This is surprising because other components, such as those found in traditional drywall, while providing flame retardancy and/or sandablility to the composition, decreased the overall flexibility.

In one embodiment, the composition includes a pigment. While in some applications, flame retardants, including, for example, boric acid, may be used as a pigment, in the context of the present disclosure, a pigment is something separate from and in addition to the flame retardant (e.g., boric acid).

In one embodiment, the pigment is a dry pigment.

In one embodiment, the pigment is a dry white pigment.

White pigment is added to provide color. The addition of a white pigment, such as titanium dioxide makes the coating into a white primer and a tint base. The coating without pigment is a clear primer.

The tint base coating can be tinted by the addition of other color pigments to create a desired color thereby forming a finish coating similar to a paint. The amount of pigment can be high enough to provide a serviceable white or pastel color for a finish coating or lower to form a dark color. The tinting can be done at the coating manufacturing site.

In one embodiment, the pigment is titanium dioxide (TiO₂). Suitable titanium dioxide pigments are TRONOX® CR-828 available from Tronox, Oklahoma City, Okla., W6R452 Rutile Titanium Dioxide White Dispersion available from Reitech Corporation, Reading, Pa., TR3 or TR60 from Huntsman Chemical and 1900 from Color Corporation of America, Rockford, Ill. The dispersion of TiO2 can be done in a glycol or glycol and water liquid.

In an embodiment, the dry pigment is present in an amount of from 10 wt %, or from 7.5 wt %, or from 5 wt %, or from 4.5 wt %, or from 4 wt % or from 3.5 wt % to 0 wt %, or to greater than 0 wt %, or to 0.5 wt %, or to 0.75 wt %, or to 1 wt %, or to 2 wt %, or to 3 wt % based on the total weight of the coating composition.

In an embodiment in which the coating composition does not include a sandable mixture, the dry pigment is present in an amount of from 10 wt %, or from 7.5 wt %, or from 5 wt %, or from 4 wt %, or from 3.5 wt % to 0 wt %, or to greater than 0 wt %, or to 0.5 wt %, or to 0.75 wt %, or to 1 wt %, or to 3 wt %, based on the total weight of the coating composition. In an embodiment in which the composition does not include a sandable mixture, the dry pigment is present in an amount of 3.125 wt %.

In an embodiment in which the coating composition includes a sandable mixture, the dry pigment is present in an amount of from 5 wt %, or from 4.5 wt %, or from 3.5 wt %, to 0 wt %, or to greater than 0 weight percent, or to 1 wt %, or to 2 wt %, or to 3 wt %, based on the total weight of the coating composition. In an embodiment in which the composition includes a sandable mixture, the pigment is present in an amount of 3.45 wt % based on the total weight of the coating composition.

In an embodiment, the dry pigment is TiO₂ and is present in an amount of from 10 wt %, or from 7.5 wt %, or from 5 wt %, or from 4.5 wt %, or from 4 wt % or from 3.5 wt % to 0 wt %, or to greater than 0 wt %, or to 0.5 wt %, or to 0.75 wt %, or to 1 wt %, or to 2 wt %, or to 3 wt % based on the total weight of the coating composition.

In an embodiment in which the coating composition does not include a sandable mixture, the dry pigment is TiO₂ and is present in an amount of from 10 wt %, or from 7.5 wt %, or from 5 wt %, or from 4 wt %, or from 3.5 wt % to 0 wt %, or to greater than 0 wt %, or to 0.5 wt %, or to 0.75 wt %, or to 1 wt %, or to 3 wt %, based on the total weight of the coating composition. In an embodiment in which the composition does not include a sandable mixture, the dry pigment is TiO₂ and is present in an amount of 3.125 wt %.

In an embodiment in which the coating composition includes a sandable mixture, the dry pigment is TiO₂ and is present in an amount of from 5 wt %, or from 4.5 wt %, or from 3.5 wt %, to 0 wt %, or to greater than 0 weight percent, or to 1 wt %, or to 2 wt %, or to 3 wt %, based on the total weight of the coating composition. In an embodiment in which the composition includes a sandable mixture, the pigment is TiO₂ and is present in an amount of 3.45 wt % based on the total weight of the coating composition.

In one embodiment, a coating composition may include an additional amount of water beyond what is provided in the base resin and/or other components of the coating composition. In embodiments, the amount of optional additional water that may be added is minimal and does not significantly change the relative amounts of the other components of the coating composition.

In some embodiments, the flame retardant (e.g., boric acid) may be supplemented by a sandable mixture to enhance or further improve the sandability of the coating composition, such as a sandable mixture comprising lime stone, gypsum, kaolin, starch, mica alsibronz and/or attapulgite clay.

In an embodiment, a sandable mixture comprises each of lime stone, gypsum, kaolin, starch, mica alsibronz and/or attapulgite clay.

In an embodiment, the lime stone is present in an amount of from 25 wt %, or from 20 wt %, or from 18 wt % to 10 wt %, or to 15 wt %, or to 17 wt % based on the total weight of the sandable mixture. In an embodiment, the lime stone is present in an amount of 17.5 wt % based on the total weight of the sandable mixture.

In an embodiment, gypsum is present in an amount of from 25 wt %, or from 20 wt %, or from 18 wt % to 10 wt %, or to 15 wt %, or to 17 wt % based on the total weight of the sandable mixture. In an embodiment, the gypsum is present in an amount of 18.66 wt % based on the total weight of the sandable mixture.

In an embodiment, kaolin is present in an amount of from 40 wt %, or from 35 wt %, or from 30 wt %, or from 28 wt % to 15 wt %, or to 20 wt %, or to 22 wt %, or to 23 wt % based on the total weight of the sandable mixture. In an embodiment, kaolin is present in an amount of 25.33 wt % based on the total weight of the sandable mixture.

In an embodiment, starch is present in an amount of from 25 wt %, or from 20 wt % or from 15 wt % to 7 wt %, or to 10 wt % or to 13 wt % based on the total weight of the sandable mixture. In an embodiment, the starch is present in an amount of 14 wt % based on the total weight of the sandable mixture.

In an embodiment, mica alsibronz is present in an amount of from 25 wt %, or from 20 wt % or from 17 wt % to 7 wt %, or to 10 wt % or to 14 wt % based on the total weight of the sandable mixture. In an embodiment, the mica alsibronz is present in an amount of 15.166 wt % based on the total weight of the sandable mixture.

In an embodiment, attapulgite clay is present in an amount of from 18 wt %, or from 15 wt %, or from 10 wt % to 5 wt %, or to 7 wt %, or to 8 wt %, or to 9 wt % based on the total weight of the sandable mixture. In an embodiment, the attapulgite clay is present in an amount of 9.33 wt % based on the total weight of the sandable mixture.

An exemplary sandable mixture is as follows:

TABLE 2

| | Example | | | |
|---|---|---|---|---|
| | (put in the CAS #s | Range | Preferred Range | Exemplary mixture |
| Component | from the attached page) | (% by weight) | (% by weight) | (% by weight) |
| Lime Stone | CAS: 1317-65-3 | 25-10 | 20-15 | 17.5 |
| | 1.05 lbs. 17.5% | | | |
| Gypsum | CAS: 1010-14-4 | 25-10 | 20-15 | 18.66 |
| | 1.12 lbs. 18.66% | | | |
| Kaolin | CAS: (China Clay) | 40-15 | 30-20 | 25.33 |
| | 1.52 lbs. 25.33% | | | |
| Starch | CAS: 9005-84-9 | 25-7 | 20-10 | 14 |
| | 0.84 lbs. 14% | | | |
| Mica Alsibronz | CAS: 12001-26-2 | 25-7 | 20-10 | 15.166 |
| | 0.91 lbs. 15.166% | | | |
| Attapulgite Clay | CAS: 12174-11-7 | 18-5 | 15-7 | 9.33 |
| | 0.56 lbs. 9.333% | | | |

In an embodiment, a sandable mixture, such as described in Table 2, is present in an amount of from 40 wt %, or from 35 wt %, or from 30 wt %, or from 25 wt %, or from 22 wt % to 0 wt %, or to greater than 0 wt %, or to 5 wt %, or to 10 wt %, or to 15 wt %, or to 18 wt %, or to 20 wt % based on the total weight of the coating composition. In an embodiment in which the coating composition includes a sandable mixture, the sandable mixture is present in an amount of from 40 wt %, or from 35 wt %, or from 30 wt %, or from 25 wt %, or from 22 wt % to 5 wt %, or to 10 wt %, or to 15 wt %, or to 18 wt %, or to 20 wt %. In an embodiment, the sandable mixture is present in an amount of from 20 wt % to 22 wt % based on the total weight of the coating composition.

In such an embodiment, and in which the composition includes a pigment, the sandable mixture is present in an amount of from 40 wt %, or from 35 wt %, or from 30 wt %, or from 25 wt %, or from 22 wt % to 0 wt %, or to greater than 0 wt %, or to 5 wt %, or to 10 wt %, or to 15 wt %, or to 18 wt %, or to 20 wt % based on the total weight of the coating composition. In such an embodiment in which the composition includes a pigment, the sandable mixture is present in an amount of from 20 wt % to 21 wt % based on the total weight of the coating composition. In such an embodiment, and in which the composition includes a pigment, the sandable mixture is present in an amount of 20.7 wt % based on the total weight of the coating composition.

In such an embodiment, and in which the composition does not include a pigment, the sandable mixture is present in an amount of from 40 wt %, or from 35 wt %, or from 30 wt %, or from 25 wt %, or from 22 wt % to 0 wt %, or to greater than 0 wt %, or to 5 wt %, or to 10 wt %, or to 15 wt %, or to 18 wt %, or to 20 wt % based on the total weight of the coating composition. In an embodiment in which the coating composition does not include a pigment, the sandable mixture is present in an amount of from 21 wt % to 22 wt % based on the total weight of the coating composition. In such an embodiment, and in which the composition includes a pigment, the sandable mixture is present in an amount of 21.47 wt % based on the total weight of the coating composition.

In one embodiment, the sandable coating comprises the following composition:

TABLE 3

| | | | | Further |
|---|---|---|---|---|
| | | Range | Preferred range | preferred range |
| Component | Example | (% by weight) | (% by weight) | (% by weight) |
| Base resin | ABRP Liquid | 70-25 | 60-30 | 55-35 |
| | Shield | | | |
| Flame Retardant | Boric Acid | 70-10 | 65-15 | 62-20 |
| Pigment | Titanium | 10-0 | 5-0 | 3.5-0 |
| | Dioxide | | | |
| Sandable | Table 4 | 40-0 | 30-0 | 25-0 |
| Mixture | | | | |

Using boric acid in an amount greater than approximately 70% reduces flexibility of the coating. Using boric acid in an amount less than approximately 30% diminishes flame retardant properties of the coating.

In one embodiment, the coating is free of wet pigments.

In one embodiment, the coating is free of wet pigments containing flammable solvents.

Table 4 includes exemplary compositions according to one or more embodiments described herein.

TABLE 4

| Component | Example 1 | | Example 2 | | Example 3 | | Example 4 | |
|---|---|---|---|---|---|---|---|---|
| Base resin | 37.5 | wt % | 38.7 | wt % | 55 | wt % | 57 | wt % |
| (ABRP | | | | | | | | |
| Liquid | | | | | | | | |
| Shield) | | | | | | | | |
| Flame | 59.375 | wt % | 61.29 | wt % | 20.7 | wt % | 21.47 | wt % |
| Retardant | | | | | | | | |
| (Boric Acid) | | | | | | | | |
| Pigment | 3.125 | wt % | 0 | wt % | 3.45 | wt % | 0 | wt % |
| (Titanium | | | | | | | | |
| Dioxide) | | | | | | | | |
| Sandable | 0 | wt % | 0 | wt % | 20.7 | wt % | 21.47 | wt % |
| Mixture | | | | | | | | |
| (Table 2) | | | | | | | | |

In the embodiments described above, the weight percent of the components is measured at the time the composition is mixed. It is understood that the percentages of each component will change as the product sits and/or cures due to, for example, evaporation, absorption of water in other components, and other processes which inherently occur as a coating composition is stored, prepared for use, and used.

### Method of Making the Coating Composition

In one embodiment, the present disclosure is a method of making a coating composition.

The coating is made by first mixing the components of the base resin thoroughly. The flame retardant (e.g., boric acid) is then added to the base resin and the mixture is again mixed thoroughly. The pigment is added last and the composition mixed thoroughly. Preferably, the composition is allowed to sit for at least 6 hours, or at least 10 hours, or at least 12 hours, or at least 18 hours, or at least 24 hours before use.

Methods of Use and/or Finishing a Surface Using a Coating Composition

In an embodiment, the present disclosure is uses for, methods of using, and methods of finishing a surface using the coating composition.

In an embodiment, that coating composition is applied to a surface (such as a wall), allowed to dry and, optionally, sanded to a desired finish.

In an embodiment, the coating composition may be applied manually directly to the surface, for example, by brushing, spraying, or other manual means.

In another embodiment, the coating composition may be applied using automated methods to a surface, for example, by passing a surface along a conveyor past an application means (e.g., spraying system).

In another embodiment, the coating composition may be applied to a temporary surface (e.g., Teflon™ or other similar surface having low adhesion to the dried coating) to a desired thickness and dimension and allowed to dry. The dried coating may then be applied to a target surface with or without the use of an adhesive. Preferably the dried coating is applied to the target surface using an adhesive. In an embodiment, the dried coating is flexible and may be applied to surfaces having contours or geometries/shapes other than flat (e.g., columns, corners, edges, etc.), as shown in FIG. F.

In an embodiment, the coating composition is viscous and sprayable. In an embodiment, the coating composition, when applied to a surface/substrate and allowed to dry, may replace plasterboard, wall board, and/or gypsum board in wall construction, such as where OSB sheathing is used. It can also be applied as a finish coating over gypsum/drywall mud. The coating composition may be used as one would drywall patching materials.

In an embodiment, the dried coating formed using the coating composition is flexible and may be used in corners without the dried coating cracking or separating.

In an embodiment, the sandable coating composition is applied to a prefabricated surface or wall, such as a SIP or wall made from SIPs. The OSB panels typically used on the outside of SIPs are rough surfaces which can be smoothed out by the sandable coating. For example, in an embodiment, the coating composition is applied to at least one of the OSB panels of a SIP and allowed to dry. Depending on the application process, the dried coating may have a desirable finished texture (rough or smooth), or the dried coating may be sanded to achieve a desired smooth coating.

FIGURE E shows an exemplary method of coating an OSB. In step A, the uncoated OSB is provided. In step B, the coating is shown applied (using a brush in the exemplary embodiment shown) to the OSB. As shown in step B, the coating is not smooth as a result of the application process. As shown in Step C, however, sanding the dry coating results in a smooth finish, even over the rough OSB. It is contemplated that different application methods (e.g., spraying) will result in a smooth finish which reduces sanding time or eliminates the step of sanding entirely, depending on the desired finish.

Sandability is important because imperfections in the surface of the dry coating must be removable to provide an acceptable finish.

In an embodiment, the dried coating is flexible and functions as a primer and/or paint. In an embodiment, the coating composition does not include a pigment, and the dried coating functions as a clear primer. In an embodiment, the coating composition includes a pigment and the dried coating functions as a colored primer. In embodiments in which the pigment is white, the dried coating is a white primer. In further embodiments, the pigment is a color other than white and the dried coating acts as a primer or final coat.

In an embodiment, the dried coating is considered flexible if a flat strip or sheet of the dried coating (after having dried on a flat surface) bends to at least 10°, or to at least 20°, or to at least 30°, or to at least 40°, or to at least 50°, or to at least 60°, or to at least 70°, or to at least 80°, or to at least 90° with no or minimal cracking, tearing or breaking, such as shown, for example, in FIGURE G. Preferably, the coating is flexible and a sheet or strip of the dried coating (after having dried on a flat surface) bends to at least 80°, or at least 85°, or at least 90° without cracking, tearing or breaking. The flexibility of the dried coating makes it suitable for application to corners, joints and irregular surfaces.

In an embodiment, the sandable coating can be used as a replacement for dry wall and paint when the coating is applied to a substrate. In an embodiment, the substrate may be a panel or other surface configured to be secured to a structure's frame (e.g., wall frame). In some embodiments, the substrate may be secured to the structure's frame and then coated with the sandable coating. In further embodiments, the substrate may be coated with the sandable coating and then secured to the structure's frame.

In an embodiment, the coating can be applied to a substrate (e.g., SIP) before shipping from the manufacturing plant. The added weight is much less than traditional drywall panels, and the coated substrate (e.g., SIP) will therefore weigh less than if traditional drywall panels were applied to the substrate at the factory/plant. This allows the plant to provide a more finished SIP to the consumer without additional weight of drywall panels.

In an embodiment, the coating can be tinted to act as a final or intermediate coating thereby removing the need for paint.

In an embodiment, the present disclosure is a surface coated with the coating composition, such as, for example, a prefabricated panel. In an embodiment, the prefabricated and coated surface (e.g., wall) can be loaded, taken to the building site, unloaded and erected without substantial damage to the coating due to the flexibility and strength of the dried composition.

In an embodiment, interior and exterior walls can be finished with the sandable coating to obtain increased strength and flexibility.

In an embodiment, once the walls of a structure are erected, the joints can be finished by applying the sandable coating alone at the joint. The sandable coating will seal and bridge small joints. Caulk or other joint sealer or fillers can be applied at the joint and coated with the sandable coating.

The coating can be formed into flexible sheets by coating a flat non-stick surface such as one having a TEFLON™ side, such as shown, for example, in FIGURE F. The coating is dried and then removed from the surface. The coating can be rolled into rolls for shipment to the user. Alternatively, the sandable coating can be provided in sheets. The coating will not stick to itself so no dividers are needed between layers. The thickness of the sandable coating can be 1 mm or any other desired thickness which will depend on the use. Depending on the surface to which the coating will be applied, the coating can be applied to the surface with or without the use of an adhesive.

The coating can be applied to the OSB board by an adhesive. Alternatively, the coating can be adhered to the OSB board by coating the OSB board with the sandable coating and applying the smooth flexible sheet of the sandable coating to the coated OSB board.

Alternatively, the sandable coating can be sprayed on to the OSB board and then troweled to an acceptable finished before or after erection at the building site. The application of the sandable coating can be like done as when applying plaster or stucco to a wall. The coating will not run when placed on a vertical wall. The coating is provided ready for use in containers. The coating cleans up with soapy water.

The dried and cured sandable coating can be sanded with sandpaper. In an embodiment, sanding the dried and cured coating using sandpaper with a grit of from 100 to 250 will result in a smooth finish without gumming up the sandpaper and without the coating crumbling/chipping. In an embodiment, the dried and cured sandable coating may be sanded using sandpaper with a grit greater than 250, however, such sanding may result in only a polishing effect and not true sanding. Regardless, the coating still does not gum up the sandpaper.

While the invention has been discussed in relation to covering OSB board, the sandable coating can be applied to plywood and other wood surfaces, drywall, metal and any other sheathing for a building, both interior and exterior to which the resin adheres or bonds.

The sandable coating can be used to cover holes in drywall, such as screw, nail and larger holes, and to fill cracks or gaps in drywall, such as at the joints.

The sandable coating can be used as a sandable paint for any surface of general use that requires a smooth surface or sandable surface. Those surfaces may not be walls of a building.

The coating is a lightweight and ready-mixed. It offers all the benefits of a conventional join compound and a finish plaster in one with less shrinkage and excellent sanding attributes. The coating has good crack-resistance, and excellent adhesion. Its formation provides little shrinkage over most surfaces.

In accordance with embodiments of the present disclosure, the coating can be applied to sheathing, plywood, OSB or concrete board on an automated conveyor system, such as that shown, for example, in FIGURE D.

The utilization of coating reduces time at installation, increases surface resistance to flammability and resistance to wood boring insects. In accordance with embodiments of the present disclosure, the he coating is paper free. In accordance with embodiments of the present disclosure, the coating requires no priming before painting and can be tinted to finish color specifications.

In accordance with embodiments of the present disclosure, the he coating uses no fasteners. In accordance with embodiments of the present disclosure, the he weight reduction per-structure is significant.
One 4′×8′×½ (32 square feet) sheet of drywall=52 pounds
One gallon of coating covers 75 to 100 square feet at 8 pounds
This is a weight reduction of 84.6%
   *not including fasteners, drywall mud and tape

In accordance with embodiments of the present disclosure, the coating conforms to regular surfaces and fills voids upon application. Its application to wood I Beam joists made from OSB conforms to shape of joists and sub floor.

In accordance with embodiments of the present disclosure, the coating can be applied on site with an airless sprayer, brush, roller and/or trowel. It may also be applied at a pre-finished facility. The product would be used by carpenters, plasterers, dry-wallers and painters. Textured or knock down finishes can be achieved using conventional means.

In accordance with embodiments of the present disclosure, the coating is nontoxic and cleans with water.

In accordance with embodiments of the present disclosure, the coating may be applied by professionals utilizing an airless sprayer designed to apply texture coatings. The pump has the ability to push viscous materials through a spray pistol and tip for smooth and accurate coats that will float out smooth requiring less sanding. Roll and brush application can be considered only if the situation requires.

In an embodiment, the sandable coating composition may be applied to walls or other surfaces over existing finishes (e.g., wallpaper, textured finishes, paneling, etc.) to provide a surface comparable to that provided by traditional drywall.

FIGURES A-C show the flame resistant nature of the coating. FIGURE A shows an OSB coated with the sandable coating and an exemplary set-up for burn tests, the results of which are reported in FIGURES B and C. FIGURE B shows the coated OSB after exposure to a torch flame (propane) 8 inches from the surface of the OSB for 10 minutes. As shown in FIGURE B, there is a small blister on the board. FIGURE C shows the coated OSB after exposure to a torch flame (propane) 6 inches away from the surface of the OSB for 10 minutes. As shown in FIGURE C, there is some charring of the board. In both tests there was no sign of combustion.

### DEFINITIONS

The terms “comprising”, “including”, “having” and their derivatives do not exclude the presence of any additional component or procedure. The term, “consisting essentially of” excludes any other component or procedure, except those essential to operability. The term “consisting of” excludes any component or procedure not specifically stated.

As used herein, the term “base resin” refers to a component of the coating composition disclosed herein and does not, by itself, amount to a coating composition, sandable coating composition or sandable coating as disclosed herein.

As used herein, the term “sandable” as used in the context of a coating or coating composition means that the dried and cured coating may be sanded using sandpaper with a 180 grit or greater, or 190 grit or greater, or 200 grit or greater, or 210 grit or greater, or 220 grit or greater without the coating crumbling and without the sandpaper being gummed up or otherwise coated with residue from the coating rendering the sandpaper unusable before the sandpaper is used up from sanding.

All percentages, preferred amounts or measurements, ranges and endpoints are inclusive, that is, “up to 10” includes 10. “At least” is equivalent to “greater than or equal to,” and “at most” is, thus, equivalent “to less than or equal to.” Numbers are approximate unless otherwise specifically noted. All ranges from a parameter described as “at least,” “greater than,” “greater than or equal to” or similarly, to a parameter described as “at most,” “up to,” “less than,” “less than or equal to” or similarly are preferred ranges regardless of the relative degree of preference indicated for each parameter. Thus a range that has an advantageous lower limit combined with a most preferred upper limit is preferred for the practice of this disclosure. The term “advantageous” is used to denote a degree of preference more than required, but less than is denoted by the term “preferably.”

The numerical ranges disclosed herein include all values from, and including, the lower and upper value. For ranged containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

It is specifically intended that the present disclosure not be limited to the embodiments and illustrations contained herein, but include modified forms of those embodiments including portions of the embodiments and combinations of elements of different embodiments as come within the scope of the following claims.

We claim:

1. A coating composition comprising:
A. 70-25 wt % of a base resin based on the total weight of the composition, wherein the base resin comprises an aqueous acrylic polymer emulsion; and
B. 70-10 wt % of a flame retardant comprising boric acid, based on the total weight of the composition.

2. The composition of claim 1 wherein the flame retardant has a regular particle size of 1-12 mils.

3. The composition of claim 1 wherein the flame retardant has a regular particle size of 5-8 mils.

4. The composition of claim 1 further comprising a pigment.

5. The composition of claim 4, wherein the pigment is present in an amount of up to 10 wt %, based on the total weight of the composition.

6. The composition of claim 5, wherein the flame retardant is present in an amount of 65-15 wt %, based on the total weight of the composition.

7. The composition of claim 6, wherein the flame retardant consists of boric acid.

8. The composition of claim 4, wherein the pigment is a dry pigment.

9. The composition of claim 8, wherein the pigment is titanium dioxide.

10. The composition of claim 9, wherein the pigment is present in an amount of from greater than 0 wt % to 3.5 wt %, based on the total weight of the composition.

11. The composition of claim 1, wherein the base resin comprises the aqueous acrylic polymer emulsion, a defoamer, water, at least one rheology modifier, at least one solvent and a surfactant.

12. A structural insulated panel comprising a middle foam panel sandwiched between two oriented strand boards, wherein at least one of the oriented strand boards is coated with the composition of claim 1.

13. A method of finishing a surface comprising:
applying a sandable coating composition to the surface, the sandable coating composition comprising 70-25 wt % of a base resin based on the total weight of the sandable coating composition, and 70-10 wt % of a flame retardant comprising boric acid,
allowing the sandable coating composition to dry, and
optionally, sanding the dried coating.

14. The method of claim 16 wherein the sandable coating composition is the composition of claim 7.

15. The method of any of claim 13 wherein the surface comprises OSB.

16. The method of any of claim 13 wherein the surface is a SIP.

17. The method of any of claims 13 wherein the dried coating is flame retardant.

18. The method of claim 13 comprising the step of sanding the dried coating.

19. The method of claim 18, wherein the step of sanding the dried coating comprises sanding the dried coating with sandpaper having a grit of up to 220.

20. A substrate coated with the composition of claim 1.

21. The coated substrate of claim 20 wherein the substrate comprises OSB.

22. A structure in combination with a sandable coating composition, the combination comprising:
a structure having a surface,
a sandable coating composition comprising 70-25 wt %, based on the total weight of the composition, of a base resin, and 70-10 wt %, based on the total weight of the composition, of a flame retardant comprising boric acid and, optionally, a pigment, the sandable coating composition applied to the surface to provide a finished or finishable surface.

23. The structure of claim 22 wherein the sandable coating composition is the composition of claim 7.

24. The structure of claim 22 wherein the surface is finishable via at least one of sanding and painting.
